(19) United States
(12) Patent Application Publication
(10) Pub. No.: US 2013/0019201 A1
(43) Pub. Date: Jan. 17, 2013

(54) Menu Configuration

(71) Applicants: Luis E. Cabrera-Cordon, Bothell, WA (US); Ching Man Esther Gall, Bellevue, WA (US); Erik L. De Bonte, Woodinville, WA (US)

(72) Inventors: Luis E. Cabrera-Cordon, Bothell, WA (US); Ching Man Esther Gall, Bellevue, WA (US); Erik L. De Bonte, Woodinville, WA (US)

(73) Assignee: MICROSOFT CORPORATION, Redmond, WA (US)

(21) Appl. No.: 13/179,988

(22) Filed: Jul. 11, 2011

(51) Int. Cl. G06F 3/048

(52) U.S. Cl. 715/810

(57) ABSTRACT

Menu configuration techniques are described. In one or more implementations, a user's orientation is determined with respect to the computing device based at least in part on a part of the user that contacts the computing device and at least one other part of a user that does not contact the computing device. A menu is displayed having an orientation on a display device of the computing device based at least in part on the determined user's orientation with respect to the computing device.

### BACKGROUND

The amount of functionality that is available from computing devices is ever increasing, such as from mobile devices, game consoles, televisions, set-top boxes, personal computers, and so on. However, traditional techniques that were employed to interact with the computing devices may become less efficient as the amount of functionality increases.

Further, the ways in which users may access this functionality may differ between devices and device configurations. Consequently, complications may arise when a user attempts to utilize access techniques in one device configuration that were created for other device configurations. For example, a traditional menu configured for interaction using a cursor-control device may become obscured, at least partially, when used by a touchscreen device.

### SUMMARY

Menu configuration techniques are described. In one or more implementations, a user's orientation is determined with respect to the computing device based at least in part on a part of the user that contacts the computing device and at least one other part of a user that does not contact the computing device. A menu is displayed having an orientation on a display device of the computing device based at least in part on the determined user's orientation with respect to the computing device.

In one or more implementations, an apparatus includes a display device; and one or more modules implemented at least partially in hardware. The one or more modules are configured to determine an order of priority to display a plurality of items in a hierarchical level of a menu and display the plurality of items on the display device arranged according to the determined order such that a first item has less of a likelihood of being obscured by a user that interacts with the display device than a second item, the first item having a priority in the order that is higher than a priority in the order of the second item.

In one or more implementations, one or more computer-readable storage media comprise instructions stored thereon that, responsive to execution by a computing device, causes the computing device to generate a menu having a plurality of items that are selectable and arranged in a radial pattern for display on a display device of the computing device, the arrangement chosen by based at least in part on whether a left or right hand of the user is being used to interact with the display device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ menu configuration techniques.

FIG. 2 depicts an example implementation showing arrangements that may be employed to position items in a menu.

FIG. 3 depicts an example implementation of output of a hierarchical level of a menu in response to selection of a menu header icon in FIG. 1.

FIG. 4 depicts an example implementation in which a result of selection of an item in a previous hierarchical level in a menu is shown as causing output of another hierarchical level in the menu.

FIG. 5 is an illustration of an example implementation in which the computing device of FIG. 1 is configured for surface computing.

FIG. 6 is an illustration of an example implementation in which users may interact with the computing device of FIG. 5 from a variety of different orientations.

FIG. 7 depicts an example implementation in which example arrangements for organizing elements in a menu based on orientation of a user are shown.

FIG. 8 depicts an example implementation in which an orientation that is detected for a user with respect to a computing device is used as a basis to orient a menu on the display device.

FIG. 9 depicts an example implementation in which a result of selection of an item in a previous hierarchical level in a menu is shown as causing output of another hierarchical level in the menu.

FIG. 10 is a flow diagram depicting a procedure in an example implementation in which a menu is configured.

FIG. 11 illustrates an example system that includes the computing device as described with reference to FIGS. 1-9.

FIG. 12 illustrates various components of an example device that can be implemented as any type of portable and/or computer device as described with reference to FIGS. 1-9 and 12 to implement embodiments of the techniques described herein.

### DETAILED DESCRIPTION

### Overview

Users may have access to a wide variety of devices that may assume a wide variety of configurations. Because of these different configurations, however, techniques that were developed for one configuration of computing device may be cumbersome when employed by another configuration of computing device, which may lead to user frustration and even cause the user to forgo use of the device altogether.

Menu configuration techniques are described. In one or more implementations, techniques are described that may be used to overcome limitations of traditional menus that were configured for interaction using a cursor control device, e.g., a mouse. For example, techniques may be employed to place items in a menu to reduce likelihood of occlusion by a user's hand that is used to interact with a computing device, e.g., provide a touch input via a touchscreen. This may be performed in a variety of ways, such as by employing a radial placement of the items that are arranged proximal to a point of contact of a user with a display device.

Additionally, orientation of the items on the display device may be based on a determined orientation of a user in relation to the display device. For example, the orientation may be based on data (e.g., images) taken using sensors (e.g., cameras) of the computing device. The computing device may then determine a likely orientation of the user and position the menu based on this orientation. Further, orientations of a plurality of different users may be supported such that different users may interact with the computing device from different orientations simultaneously.

Further, techniques may be employed to choose an arrangement based on whether a user is likely interacting with the display device using a left or right hand, thereby further reducing a likelihood of obscuring the items in the menu. Yet further, techniques may also be employed to prioritize the items in an order based on likely relevance to a user such that higher priority items have a less of a likelihood of being obscured that items having a lower priority. A variety of other techniques are also contemplated, further discussion of which may be found in relation to the following figures.

In the following discussion, an example environment is first described that is operable to employ the menu configuration techniques described herein. Example illustrations of gestures and procedures involving the gestures are then described, which may be employed in the example environment as well as in other environments. Accordingly, the example environment is not limited to performing the example gestures and procedures. Likewise, the example procedures and gestures are not limited to implementation in the example environment.

Example Environment

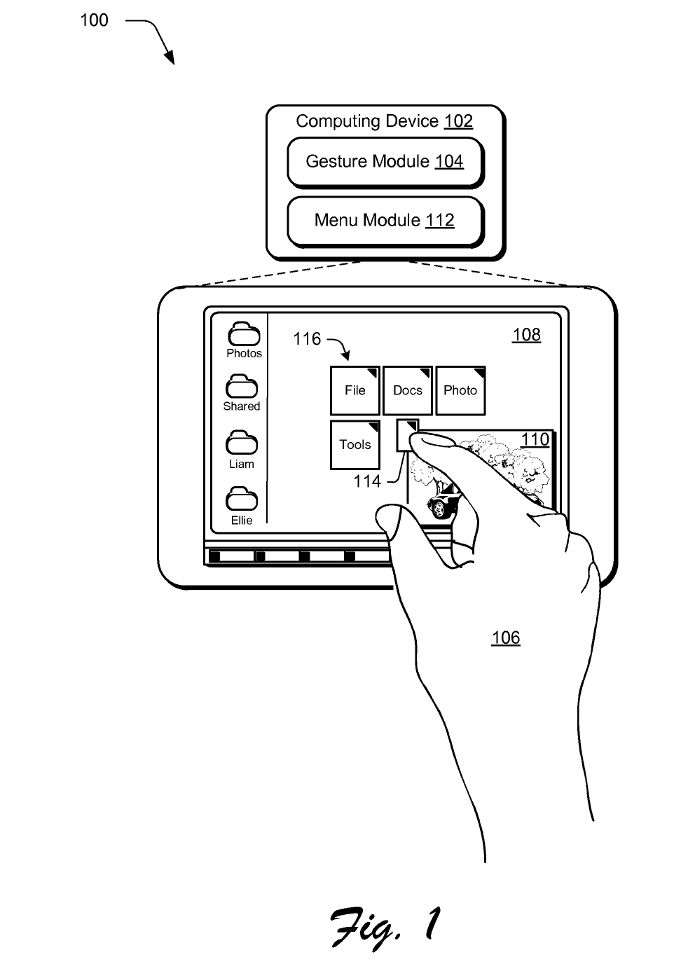

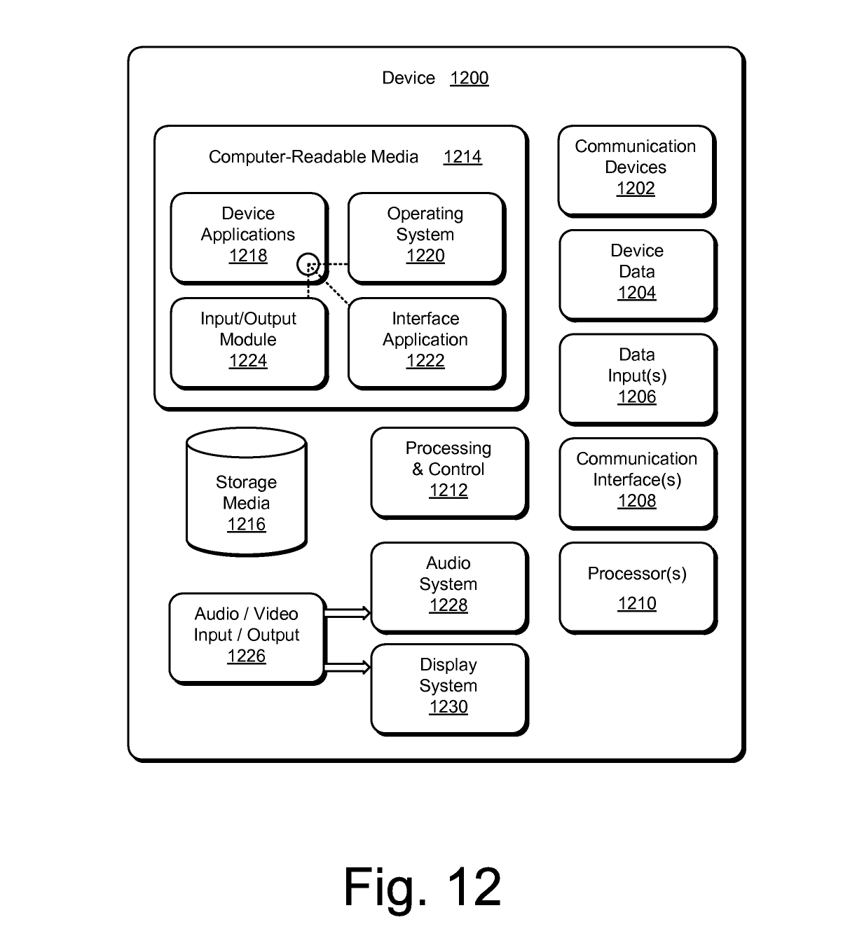

FIG. 1 is an illustration of an environment 100 in an example implementation that is operable to employ menu configuration techniques. The illustrated environment 100 includes an example of a computing device 102 that may be configured in a variety of ways. For example, the computing device 102 may be configured as a traditional computer (e.g., a desktop personal computer, laptop computer, and so on), a mobile station, an entertainment appliance, a set-top box communicatively coupled to a television, a wireless phone, a netbook, a game console, and so forth as further described in relation to FIG. 12. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is illustrated as including a gesture module 104. The gesture module 104 is representative of functionality to identify gestures and cause operations to be performed that correspond to the gestures. The gestures may be identified by the gesture module 104 in a variety of different ways. For example, the gesture module 104 may be configured to recognize a touch input, such as a finger of a user's hand 106 as proximal to a display device 108 of the computing device 102 using touchscreen functionality.

The touch input may also be recognized as including attributes (e.g., movement, selection point, etc.) that are usable to differentiate the touch input from other touch inputs recognized by the gesture module 104. This differentiation may then serve as a basis to identify a gesture from the touch inputs and consequently an operation that is to be performed based on identification of the gesture.

For example, a finger of the user's hand 106 is illustrated as selecting an image 110 displayed by the display device 108. Selection of the image 110 and subsequent movement of the finger of the user's hand 106 across the display device 108 may be recognized by the gesture module 104. The gesture module 104 may then identify this recognized movement as a movement gesture to initiate an operation to change a location of the image 110 to a point in the display device 108 at which the finger of the user's hand 106 was lifted away from the display device 108. Therefore, recognition of the touch input that describes selection of the image, movement of the selection point to another location, and then lifting of the finger of the user's hand 106 from the display device 108 may be used to identify a gesture (e.g., movement gesture) that is to initiate the movement operation.

In this way, a variety of different types of gestures may be recognized by the gesture module 104. This includes gestures that are recognized from a single type of input (e.g., touch gestures such as the previously described drag-and-drop gesture) as well as gestures involving multiple types of inputs. Additionally, the gesture module 104 may be configured to differentiate between inputs and therefore the number of gestures that are made possible by each of these inputs alone is also increased. For example, although the inputs may be similar, different gestures (or different parameters to analogous commands) may be indicated using touch inputs versus stylus inputs. Likewise, different inputs may be utilized to initiate the same gesture.

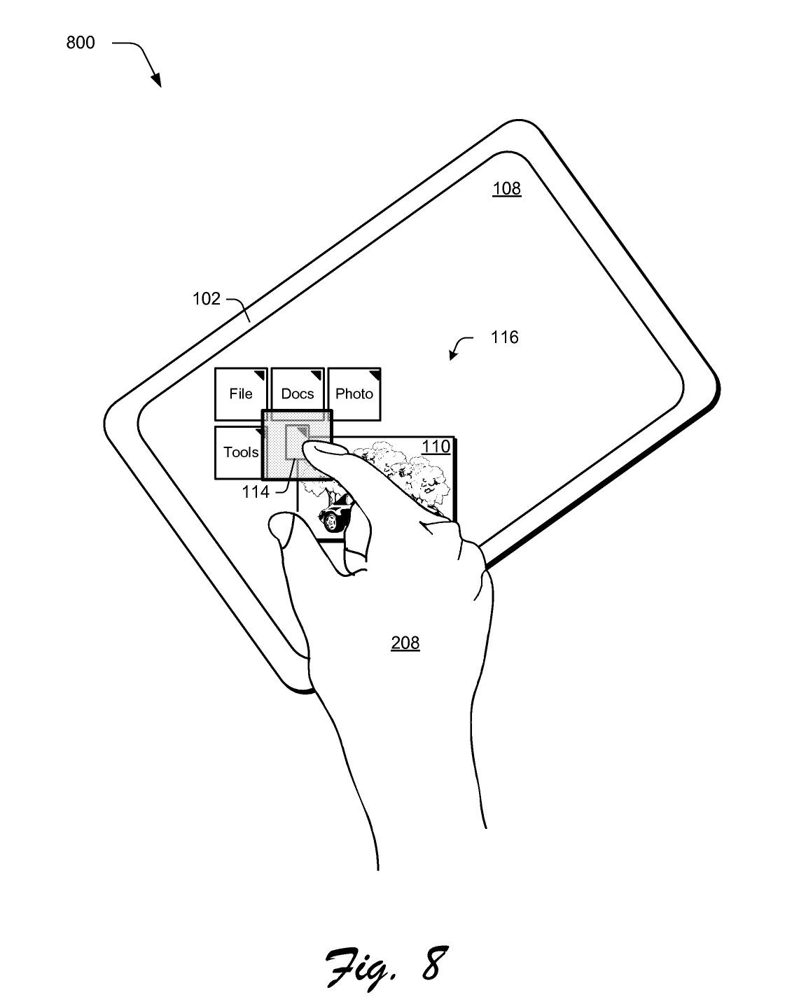

Additionally, although the following discussion may describe specific examples of inputs, in instances the types of inputs may be defined in a variety of ways to support the same or different gestures without departing from the spirit and scope thereof. Further, although in instances in the following discussion the gestures are illustrated as being input using touchscreen functionality, the gestures may be input using a variety of different techniques by a variety of different devices such as depth-sensing cameras, further discussion of which may be found in relation to the FIG. 8.

The computing device 102 is further illustrated as including a menu module 112. The menu module 112 is representative of functionality of the computing device 102 relating to menus. For example, the menu module 112 may employ techniques to reduce occlusion caused by a user (e.g., the user's hand 106) when interacting with the display device 108, e.g., to utilize touchscreen functionality.

For example, a finger of the user's hand 106 may be used to select a menu header icon 114, which is illustrated at a top-left corner of the image 110. The menu module 112 may be configured to display the menu header icon 114 responsive to detection of interaction of a user with a corresponding item, e.g., the image 110 in this example. For instance, the menu module 112 may detect proximity of the finger of the user's hand 106 to the display of the image 110 to display the menu header icon 114. Other instances are also contemplated, such as to continually display the menu header icon 114 with the image. The menu header icon 114 includes an indication displayed as a triangle in an upper-right corner of the icon to indicate that additional items in a menu are available for display upon selection of the icon.

The menu header icon 114 may be selected in a variety of ways. For instance, a user may “tap” the icon similar to a “mouse click.” In another instance, a finger of the user's hand 106 may be held “over” the icon (e.g., hover) to cause output of the items in the menu. In response to selection of the menu header icon 114, the menu module 112 may cause output of a hierarchical level 116 of a menu that includes a plurality of items that are selectable. Illustrated examples of selectable items include “File,” “Docs,” “Photo,” and “Tools.” Each of these items is further illustrated as including an indication that an additional level in the hierarchical menu is available through selection of the item, which is illustrated as a triangle in the upper-right corner of the items.

The items are also positioned for display by the menu module 112 such that the items are not obscured by the user's hand 106, as opposed to how the image 110 is partially obscured in the illustrated example. For instance, the items may be arranged radially from a point of contact of the user, e.g., the finger of the user's hand 106 when selecting the menu header icon 114. Thus, a likelihood is reduced that any one of the items in the hierarchical level 116 of the menu being displayed is obscured for viewing by a user by the user's hand 106. The items in the menu may be arranged in a variety of ways, examples of which may be found in relation to the following figure.

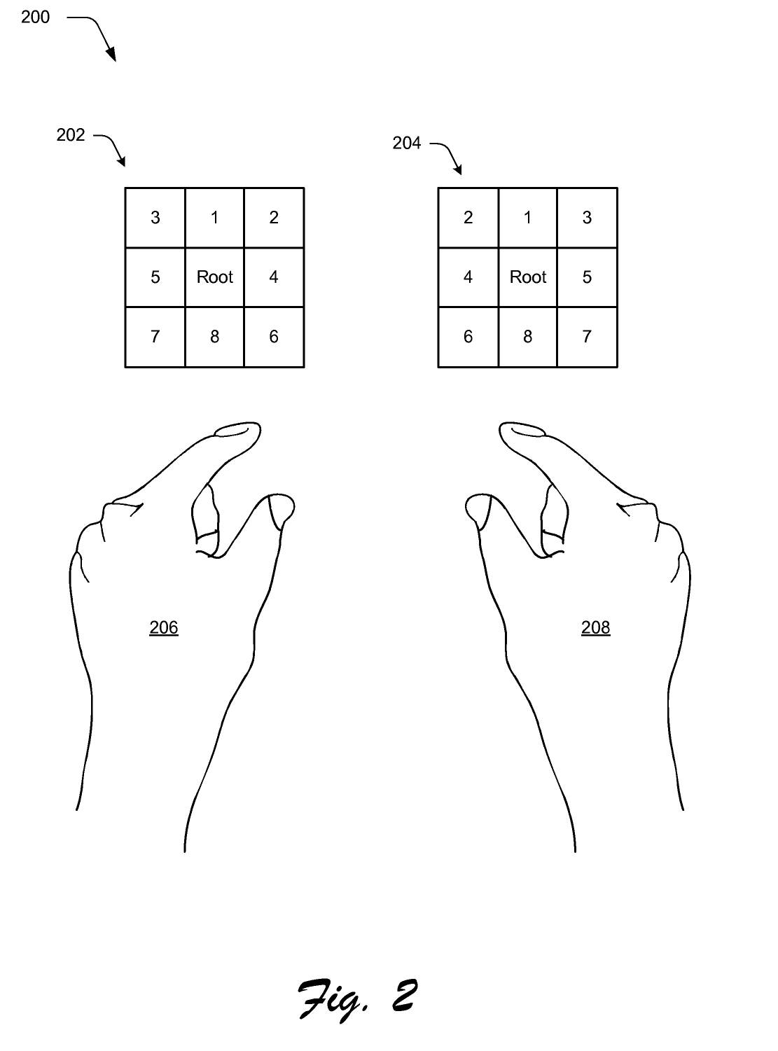

FIG. 2 depicts an example implementation 200 showing arrangements that may be employed to position items in a menu. This example implementation 200 illustrates left and right hand arrangements 202, 204. In each of the arrangements, numbers are utilized to indicate a priority in which to arrange items in the menu. Further, these items are arranged around a root item, such as an item that was selected in a previous hierarchical level of a menu to cause output of the items.

As illustrated in both the left and right hand arrangements 202, 204, an item having a highest level of priority (e.g., “1”) is arranged directly above the root item whereas an item having a relatively lowest level of priority in the current output is arranged directly below the root item. Beyond this, the arrangements are illustrated as diverging to increase a likelihood that items having a higher level of priority have a less likelihood of being obscured by the user's hand that is being used to interact with the menu, e.g., the left hand 206 for the left hand arrangement 202 and the right hand 208 for the right hand arrangement 204.

As shown in the left and right hand arrangements 202, 204, for instance, second and third items in the arrangement are positioned to appear above a contact point of a user, e.g., fingers of the user's hands 206, 208. The second item is positioned away from the user's hands 206, 208 and the third item is positioned back toward the user's hands 206, 208 along the top level in the illustrated examples. Accordingly, in the left hand arrangement 202 the order for the first three items is “3,” “1,” “2” left to right along a top level whereas the order for the first three items is “2”, “1”, “3” left to right along the level of the right hand arrangement 204. Therefore, these items have an increased likelihood of being viewable by a user even when a finger of the user's hand is positioned over the root item.

Items having a priority of “4” and “5” in the illustrated example are positioned at a level to coincide with the root item. The “4” item is positioned beneath the “2” item and away from the user's hands 206, 208 in both the left and right hand arrangements 202, 204. The “5” item is positioned on an opposing side of the root item from the “4” item. Accordingly, in the left hand arrangement 202 the order for the items is “5,” “root,” “4” left to right along a level whereas the order for the items is “4”, “root”, “5” left to right in the right hand arrangement 204. Therefore, in this example the “4” item has a lesser likelihood of be obscured by the user's hands 206, 208 than the “5” item.

Items having a priority of “6,” “7,” and “8” in the illustrated example are positioned at a level beneath the root item. The “6” item is positioned beneath the “4” item and away from the user's hands 206, 208 in both the left and right hand arrangements 202, 204. The “8” item is positioned directly beneath the root item in this example and the “7” item is beneath the “5” item. Accordingly, in the left hand arrangement 202 the order for the items is “7”, “8”, “6” left to right along a level whereas the order for the items is “6”, “8”, “7” left to right in the right hand arrangement 204. Therefore, in this example the “6” item has a decreased likelihood of be obscured by the user's hands 206, 208 than the “7” and “8” items, and so on.

Thus, in these examples an order of priority may be leveraged along with an arrangement to reduce a likelihood that items of interest in a hierarchical level are obscured by a user's touch of a display device. Further, different arrangements may be chosen based on identification of whether a left or right hand 206, 208 of the user is used to interact with the computing device 102, e.g., a display device 108 having touchscreen functionality. Examples of detection and navigation through hierarchical levels may be found in relation to the following figures.

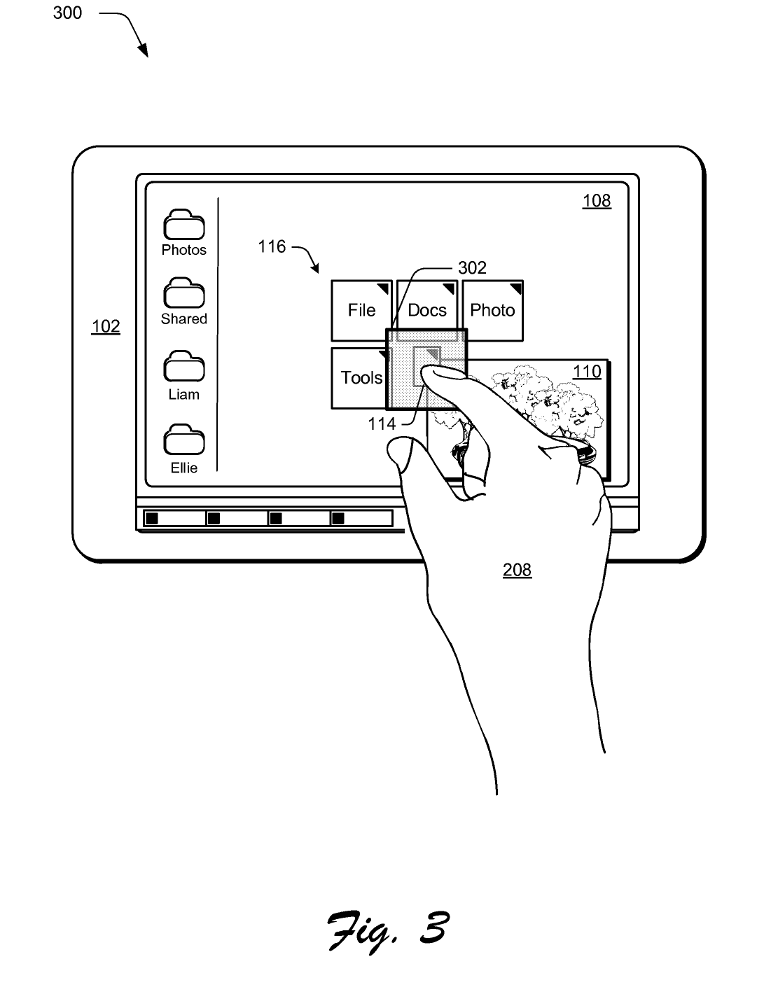

FIG. 3 depicts an example implementation showing output of a hierarchical level of a menu responsive to selection of a root item. In the illustrated example, a right hand 208 of a user is illustrated as selecting a menu header icon 114 by placing a finger against a display device 108. Responsive to detecting this selection, the menu module 112 causes output of items the hierarchical level 116 of the menu as described in relation to FIG. 1.

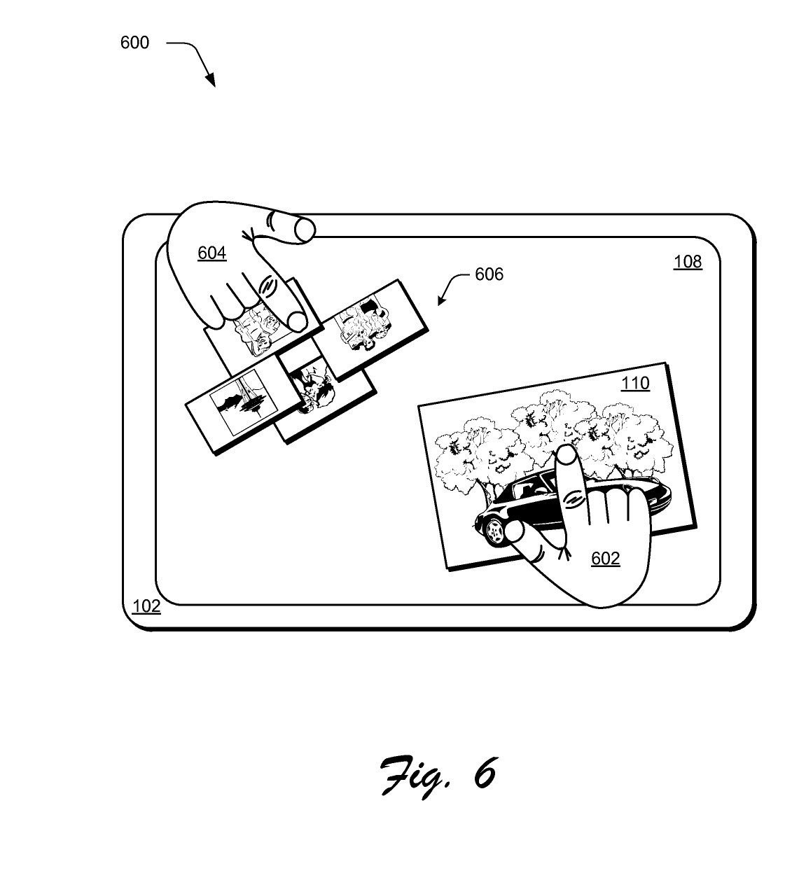

Additionally, the menu module 112 may determine whether a user's left or right hand is being used to make the selection. This determination may be performed in a variety of ways, such as based on a contact point with the display device 108, other data that may be collected that describes parts of the user's body that do not contact the computing device 102, and so on, further discussion of which may be found in relation to FIGS. 6-9.

In the illustrated example, the menu module 112 determines that the user's right hand 208 was used to select the menu header icon 114 and accordingly uses the right hand arrangement 204 from FIG. 2 to position items in the hierarchical level 116. A visual indication 302 is also illustrated as being displayed as surrounding a contact point of the finger of the user's hand 106. The visual indication is configured to indicate that a selection may be made by dragging of a touch input (e.g., the finger of the user's hand 106) across the display device 108. Thus, the menu module 112 may provide an indication that drag gestures are available, which may help users such as traditional cursor control device users that are not familiar with drag gestures to discover availability of the drag gestures.

The visual indication 302 may be configured to follow movement of the touch input across the surface of the display device 108. For example, the visual indication 302 is illustrated as surrounding an initial selection point (e.g., the menu header icon 114) in FIG. 3. The visual indication 302 in this example is illustrated as including a border and being translucent to view an “underlying” portion of the user interface. In this way, the user may move the touch input (e.g., the finger of the user's hand 106) across the display device 108 and have the visual indication 302 follow this movement to select an item, an example of which is shown in the following figures.

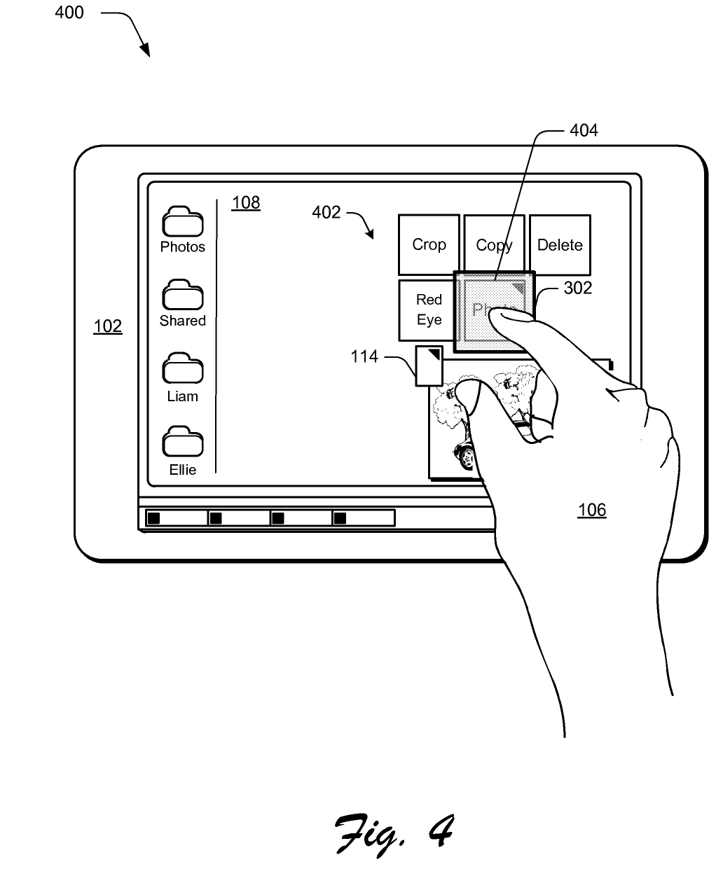

FIG. 4 depicts an example implementation 400 in which a result of selection of an item in a previous hierarchical level 116 in a menu is shown as causing output of another hierarchical level 402 in the menu. In this example, the photo 404 item is selected through surrounding the item using the visual indication 302 for a predefined amount of time.

In response, the menu module 112 causes a sub-menu of items from another hierarchical level 402 in the menu to be output that relate to the photo 302 item. The illustrated examples include “crop,” “copy,” “delete,” and “red eye.” In an implementation, the menu module 112 may leverage the previous detection of whether a right or left hand was used initially to choose an arrangement. Additional implementations are also contemplated, such as to detect when a user has “changed hands” and thus choose a corresponding arrangement based on the change.

In the example implementation 400 of FIG. 4, the items included at this hierarchical level 402 are representative of commands to be initiated and are not representative of additional hierarchical levels in the menu. This is indicated through lack of a triangle in the upper-right corner of the items in this example. Therefore, a user may continue the drag gesture toward a desired one of the items to initiate a corresponding operation. A user may then “lift” the touch input to cause the represented operation to be initiated, may continue selection of the item for a predetermined amount of time, and so on to make the selection.

In the illustrated example, the previous item or items that were used to navigate to a current level in the menu remain displayed. Therefore, a user may select these other items to navigate back through the hierarchy to navigate through different branches of the menu. For example, the touch input may be dragged to the menu header icon 114 to return to the hierarchical level 116 of the menu shown in FIG. 2.

If the user desires to exit from navigating through the menu, the touch input may be dragged outside of a boundary of the items in the menu. Availability of this exit without selecting an item may be indicated by removing the visual indication 302 from display when outside of this boundary. In this way, a user may be readily informed that an item will not be selected and it is “safe” to remove the touch input without causing an operation of the computing device 102 to be initiated.

The menu module 112 may also be configured to take into account the available display area for the arrangement and ordering of the items in the menu. For example, suppose that a sufficient amount of display area is not available for the top level of the arrangement, i.e., to display the first three items above the root item. The menu module 112 may detect this and then “move down” the items in the priority to spots that are available, e.g., to display the three items having the highest priority in spots “4”, “5,” and “6” in the arrangements shown in FIG. 2. Thus, the menu module 112 may dynamically adapt to availability of space on the display device 108 to display the menu.

Although drag gestures were described above, the menu module 112 may also support tap gestures. For example, the menu module 112 may be configured to output the menu and/or different levels of the menu for a predefined amount of time. Therefore, even if a touch input is removed (e.g., the finger of the user's hand is removed from the display device 108), a user may still view items and make a selection by tapping on an item in the menu to be selected.

Additionally, this amount of time may be defined to last longer in response to recognition of a tap gesture. Thus, the menu module 112 may identify a type of user (e.g., cursor control versus touchscreen) and configure interaction accordingly, such as to set the amount of time the menu is to be displayed without receiving a selection.

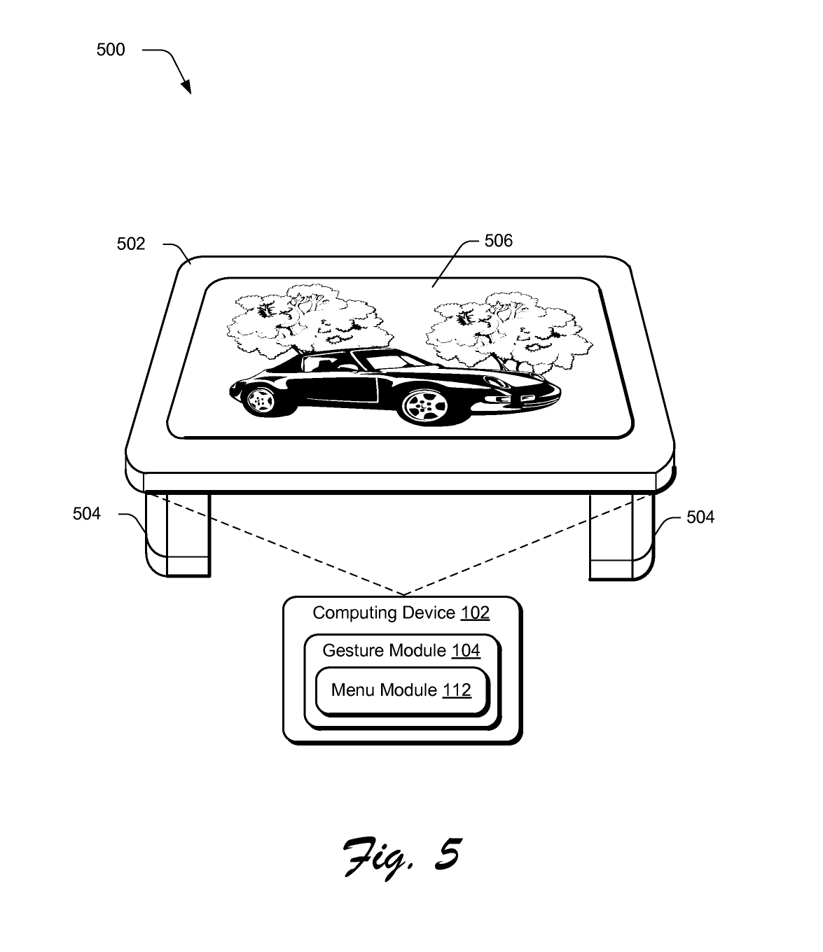

FIG. 5 is an illustration of an environment 500 in an example implementation in which the computing device 102 of FIG. 1 is configured for surface computing. In the illustrated environment 500, the computing device 102 is illustrated as having a form factor of a table. The table form factor includes a housing 502 having a plurality of legs 504. The housing 502 also includes a table top having a surface 506 that is configured to display one or more images (e.g., operate as a display device 108), such as the car as illustrated in FIG. 5. It should be readily apparent that a wide variety of other data may also be displayed, such as documents and so forth.

The computing device 102 is further illustrated as the gesture module 104 and menu module 112. The gesture module 104 may be configured in this example to provide computing related functionality that leverages the surface 506. For example, the gesture module 104 may be configured to output a user interface via the surface 506. The gesture module 104 may also be configured to detect interaction with the surface 506, and consequently the user interface. Accordingly, a user may then interact with the user interface via the surface 506 in a variety of ways.

For example, the user may use one or more fingers as a cursor control device, as a paintbrush, to manipulate images (e.g., to resize and move the images), to transfer files (e.g., between the computing device 102 and another device), to obtain content via a network by Internet browsing, to interact with another computing device (e.g., the television) that is local to the computing device 102 (e.g., to select content to be output by the other computing device), and so on. Thus, the gesture module 104 of the computing device 102 may leverage the surface 506 in a variety of different ways both as an output device and an input device.

The menu module 112 may employ techniques to address display and interaction in such a configuration. As shown in FIG. 6, for instance, users may interact with the computing device 102 from a variety of different orientations. A hand 602 of a first user, for example, is shown as interacting with the image 110 of the car from a first side of the computing device 102 whereas a hand 604 of a second user is shown as interacting with images 606 from an opposing side of the computing device 102. In one or more implementations, the menu module 112 may leverage a determination of an orientation of a user to arrange a menu, as further described in the following figure.

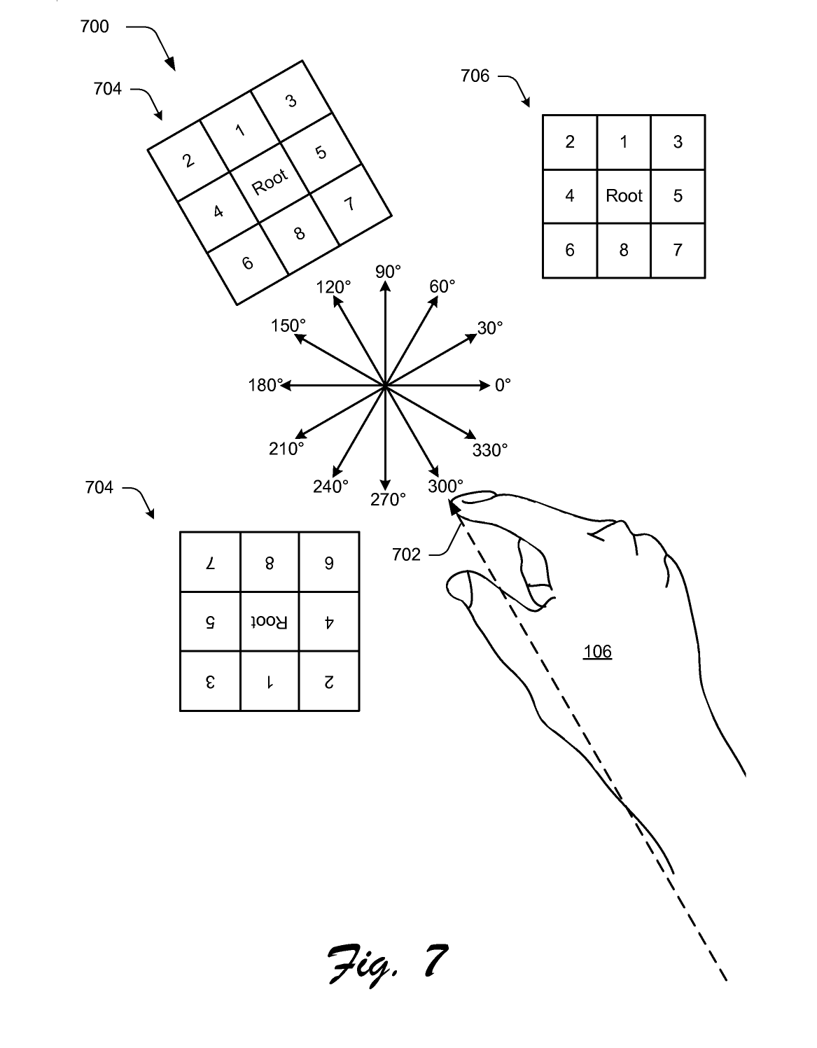

FIG. 7 depicts an example implementation 700 in which example arrangements for organizing elements in a menu based on orientation of a user are shown. As previously described, the menu module 112 may choose an arrangement based on whether a right or left hand of a user is being utilized to interact with the computing device 102. In this example, the menu module 112 has determined that a right hand 106 of a user is being used to select an item on the display device 108.

The menu module 112 may also base an orientation in which the arrangement is to be displayed based on a likely orientation of a user with respect to the computing device 102, e.g., the display device 108. For example, the gesture module 104 may receive data captured from one or more sensors, such as infrared sensors, a camera, and so on of the computing device 102 or other devices.

The gesture module 104 may then examine this data to determine a likely orientation of a user with respect to the computing device 102, such as a display device 108. For instance, an orientation of a finger of the user's hand 106 may be determined by a portion that contacts the display device 108, such as a shape of that portion.

In another instance, other non-contacting portions of a user's body may be leveraged. For example, the computing device 102 may employ cameras positioned within the housing 502, e.g., beneath the surface 506 of the device. These cameras may capture images of a portion of a user that contacts the surface as well as portions that do not, such as a user's arm, other fingers of the user's hand, and so on. Other examples are also contemplated, such as through the use of depth-sensing cameras, microphones, and other sensors.

A determined orientation 702 is illustrated through use of an arrow in the figure. This orientation 702 may then be used by the menu module 112 to determine an orientation in which to position the arrangement. As illustrated in FIG. 7, the menu module may choose an orientation 704 for an arrangement that approximately matches the orientation 702 determined for the user, which in this case is approximately 120 degrees.

In another example, inclusion of the orientation 702 within a specified range may be used to choose an orientation for the arrangement. For instance, if the determined orientation of the user falls within zero to 180 degrees a first orientation 706 for the arrangement may be chosen. Likewise, if the determined orientation of the user falls within 180 to 360 degrees a second orientation 704 may be chosen. Thus, the orientation chosen for the arrangement may be based on the orientation of the user in a variety of ways. Additional examples of display of the menu based on orientation may be found in relation to the following figures.

FIG. 8 depicts an example implementation in which an orientation that is detected for a user with respect to a computing device is used as a basis to orient a menu on the display device 108. As before, the menu module 112 may determine that the user's right hand 208 was used to select the menu header icon 114 and accordingly use the right hand arrangement 204 from FIG. 2 to position items in the hierarchical level 116. Additionally, this direction may be independent of an orientation of items that are currently displayed on the display device 108.

In this example, however, the menu module 112 also orients the items in the menu based on the orientation. In this illustrated example, the items in the hierarchical level 116 of the menu follow an orientation that matches the orientation of the user's right hand 208. Thus, users may orient themselves around the computing device 102 and have the computing device take that into account when configuring a user interface. This orientation may also be used to for subsequent interaction with the menu without re-computing the orientation.

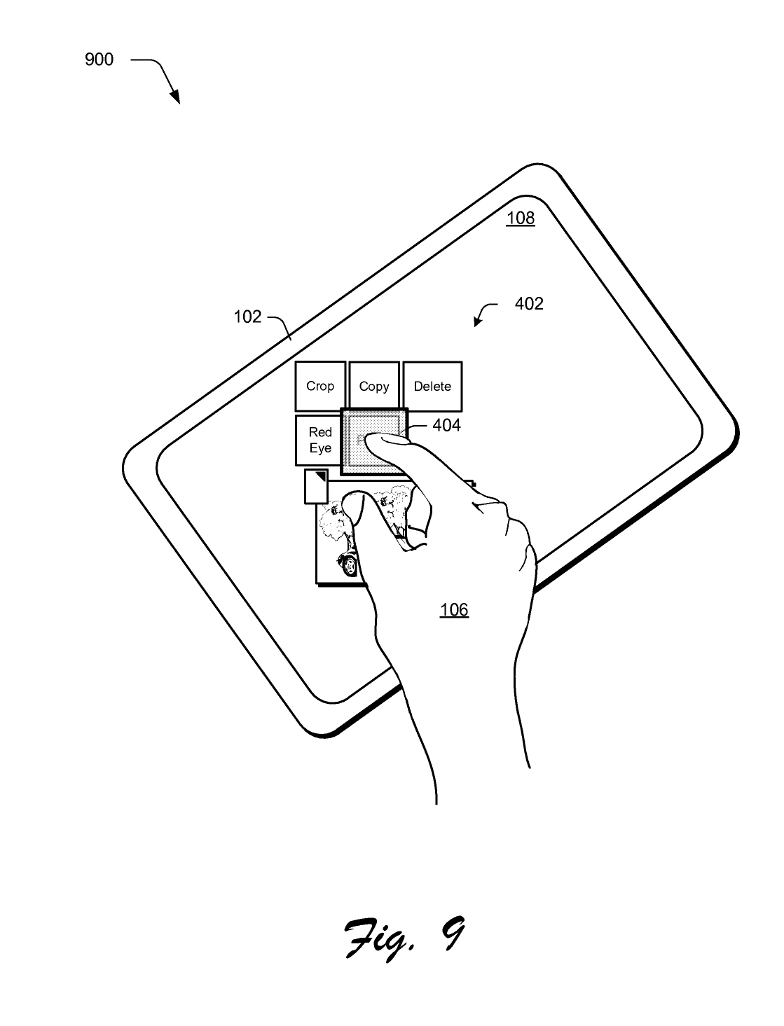

As shown in FIG. 9, for instance, an example implementation 900 is illustrated in which a result of selection of an item in a previous hierarchical level 116 of FIG. 8 in a menu is shown as causing output of another hierarchical level 402 in the menu. In this example, the photo 404 item is indicated as selected through surrounding of the item using a visual indication, e.g., the box having the border.

In response, the menu module 112 causes a sub-menu of items from another hierarchical level 402 in the menu to be output that related to the photo 404 item. In an implementation, the menu module 112 may leverage the previous detection of whether a right or left hand was used initially to choose an arrangement as well as the determination of orientation. Additional implementations are also contemplated, such as to detect that a user's orientation has changed past a threshold amount and thus compute a new orientation. Further discussion of this and other techniques may be found in relation to the following procedure.

Generally, any of the functions described herein can be implemented using software, firmware, hardware (e.g., fixed logic circuitry), or a combination of these implementations. The terms “module,” “functionality,” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the computing device 102 may also include an entity (e.g., software) that causes hardware of the computing device 102 to perform operations, e.g., processors, functional blocks, and so on. For example, the computing device 102 may include a computer-readable medium that may be configured to maintain instructions that cause the computing device, and more particularly hardware of the computing device 102 to perform operations. Thus, the instructions function to configure the hardware to perform the operations and in this way result in transformation of the hardware to perform functions. The instructions may be provided by the computer-readable medium to the computing device 102 through a variety of different configurations.

One such configuration of a computer-readable medium is signal bearing medium and thus is configured to transmit the instructions (e.g., as a carrier wave) to the hardware of the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Example Procedures

The following discussion describes menu techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the example implementations 200-900 of FIGS. 2-9, respectively.

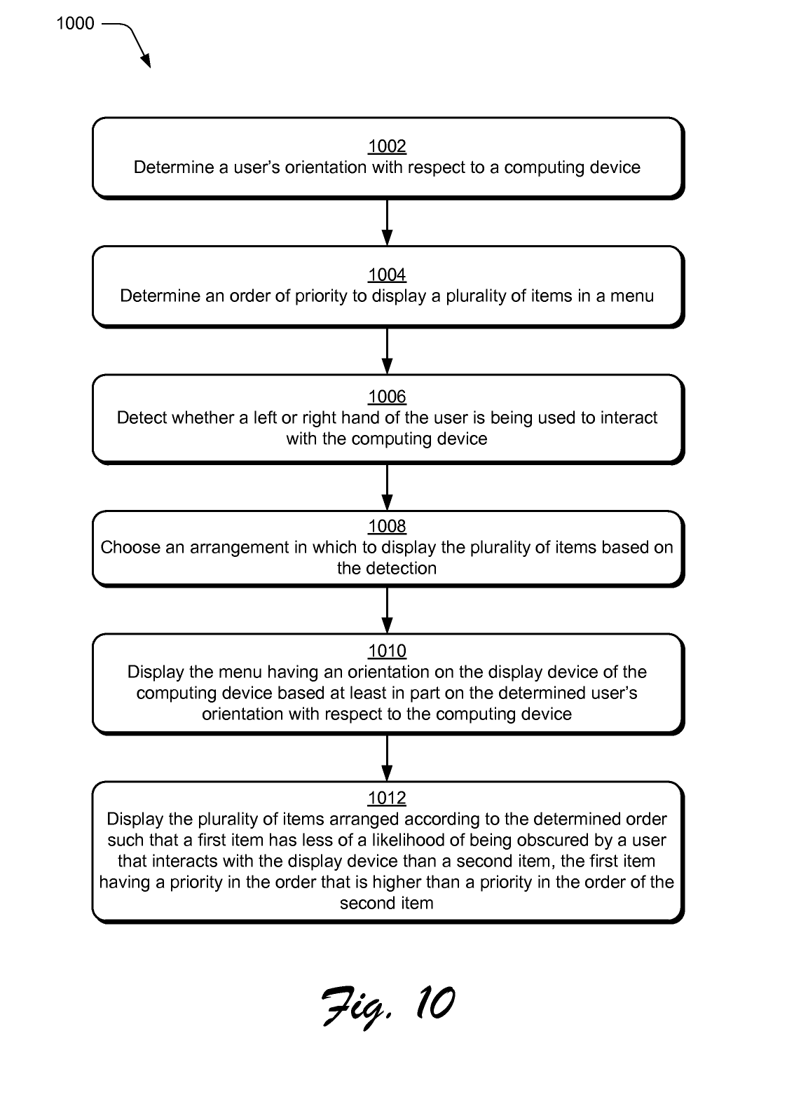

FIG. 10 depicts a procedure 1000 in an example implementation in which a menu is configured. A determination is made as to a user's orientation with respect to a computing device (block 1002). The computing device 102, for instance, may utilize a microphone, camera, acoustic wave device, capacitive touchscreen, and so on to determine the user's orientation. This determination may be based on a part of a user that contacts the computing device 102 (e.g., the display device 108) as well as a part of the user that does not contact the computing device 102, e.g., the rest of the user's hand.

An order of priority is determined to display a plurality of items in a menu (block 1004). Items in a menu may be arranged in a priority for display. This priority may be based on a variety of factors, such as a likelihood that the item is of interest to a user, heuristics, frequency of use, and so on.

The computing device also detects whether a left or right hand of a user is being used to interact with the computing device (block 1006). As before, this detection may be performed in a variety of ways as previously described in relation to FIG. 2. An arrangement is then chosen in which to display the plurality of items based on the detection (block 1008), such as an arrangement optimized for use by the left or right hand based on the detection.

The menu is displayed as having an orientation on the display device of the computing device based at least in part on the determined user's orientation with respect to the computing device (block 1010). The menu module 112 may also orient the arrangement in a user interface on a display device 108. This orientation may be configured to match a user's orientation with respect to the computing device 102, defined for ranges, and so forth.

The plurality of items are then displayed as arranged according to the determined order such that a first item has less of a likelihood of being obscured by a user that interacts with display device than a second item, the first item having a priority in the order that is higher than a priority in the order of the second item (block 1012). Thus, the priority, arrangement, and orientation may be used to configure the menu to promote ease of use.

Example System and Device

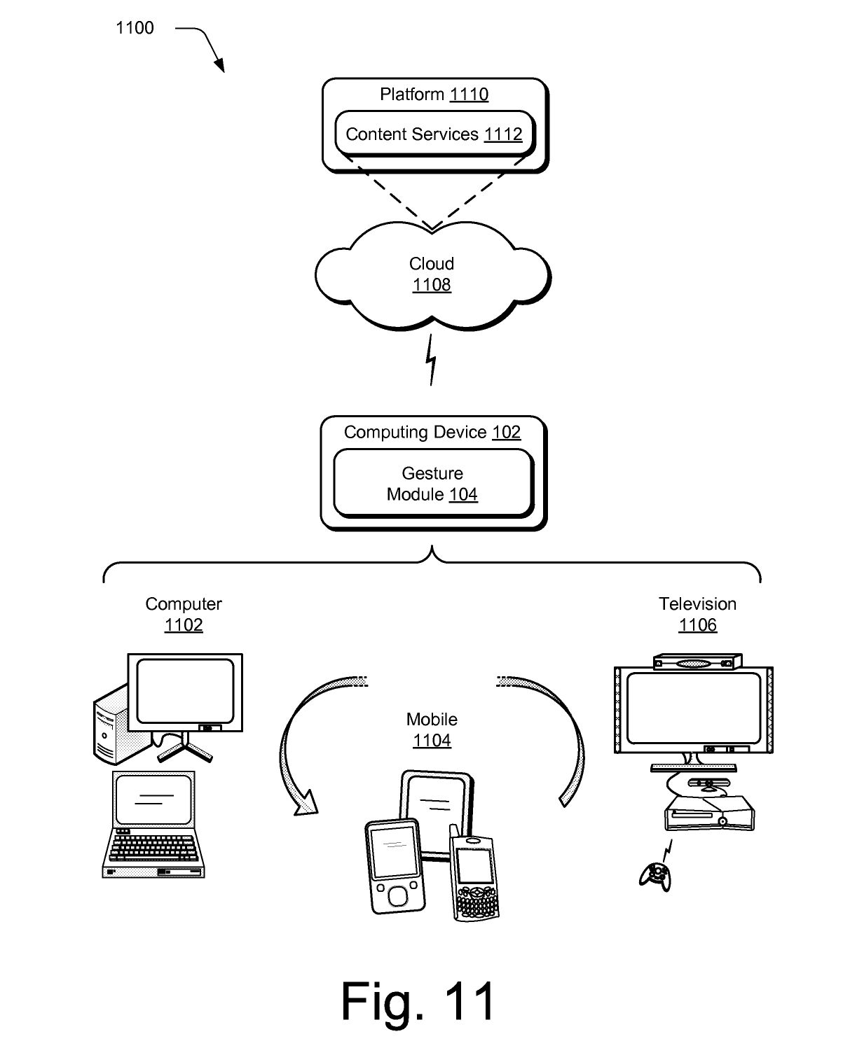

FIG. 11 illustrates an example system 1100 that includes the computing device 102 as described with reference to FIG. 1. The example system 1100 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 1100, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link. In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 102 may assume a variety of different configurations, such as for computer 1102, mobile 1104, and television 1106 uses. Each of these configurations includes devices that may have generally different constructs and capabilities, and thus the computing device 102 may be configured according to one or more of the different device classes. For instance, the computing device 102 may be implemented as the computer 1102 class of a device that includes a personal computer, desktop computer, a multi-screen computer, laptop computer, netbook, and so on.

The computing device 102 may also be implemented as the mobile 1104 class of device that includes mobile devices, such as a mobile phone, portable music player, portable gaming device, a tablet computer, a multi-screen computer, and so on. The computing device 102 may also be implemented as the television 1106 class of device that includes devices having or connected to generally larger screens in casual viewing environments. These devices include televisions, set-top boxes, gaming consoles, and so on. The techniques described herein may be supported by these various configurations of the computing device 102 and are not limited to the specific examples the techniques described herein.

The cloud 1108 includes and/or is representative of a platform 1110 for content services 1112. The platform 1110 abstracts underlying functionality of hardware (e.g., servers) and software resources of the cloud 1108. The content services 1112 may include applications and/or data that can be utilized while computer processing is executed on servers that are remote from the computing device 102. Content services 1112 can be provided as a service over the Internet and/or through a subscriber network, such as a cellular or Wi-Fi network.

The platform 1110 may abstract resources and functions to connect the computing device 102 with other computing devices. The platform 1110 may also serve to abstract scaling of resources to provide a corresponding level of scale to encountered demand for the content services 1112 that are implemented via the platform 1110. Accordingly, in an interconnected device embodiment, implementation of functionality of the functionality described herein may be distributed throughout the system 1100. For example, the functionality may be implemented in part on the computing device 102 as well as via the platform 1110 that abstracts the functionality of the cloud 1108, as shown through inclusion of the gesture module 104.

FIG. 12 illustrates various components of an example device 1200 that can be implemented as any type of computing device as described with reference to FIGS. 1, 2, and 11 to implement embodiments of the techniques described herein. Device 1200 includes communication devices 1202 that enable wired and/or wireless communication of device data 1204 (e.g., received data, data that is being received, data scheduled for broadcast, data packets of the data, etc.). The device data 1204 or other device content can include configuration settings of the device, media content stored on the device, and/or information associated with a user of the device. Media content stored on device 1200 can include any type of audio, video, and/or image data. Device 1200 includes one or more data inputs 1206 via which any type of data, media content, and/or inputs can be received, such as user-selectable inputs, messages, music, television media content, recorded video content, and any other type of audio, video, and/or image data received from any content and/or data source.

Device 1200 also includes communication interfaces 1208 that can be implemented as any one or more of a serial and/or parallel interface, a wireless interface, any type of network interface, a modem, and as any other type of communication interface. The communication interfaces 1208 provide a connection and/or communication links between device 1200 and a communication network by which other electronic, computing, and communication devices communicate data with device 1200.

Device 1200 includes one or more processors 1210 (e.g., any of microprocessors, controllers, and the like) which process various computer-executable instructions to control the operation of device 1200 and to implement embodiments of the techniques described herein. Alternatively or in addition, device 1200 can be implemented with any one or combination of hardware, firmware, or fixed logic circuitry that is implemented in connection with processing and control circuits which are generally identified at 1212. Although not shown, device 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1200 also includes computer-readable media 1214, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1200 can also include a mass storage media device 1216.

Computer-readable media 1214 provides data storage mechanisms to store the device data 1204, as well as various device applications 1218 and any other types of information and/or data related to operational aspects of device 1200. For example, an operating system 1220 can be maintained as a computer application with the computer-readable media 1214 and executed on processors 1210. The device applications 1218 can include a device manager (e.g., a control application, software application, signal processing and control module, code that is native to a particular device, a hardware abstraction layer for a particular device, etc.). The device applications 1218 also include any system components or modules to implement embodiments of the techniques described herein. In this example, the device applications 1218 include an interface application 1222 and an input/output module 1224 (which may be the same or different as input/output module 114) that are shown as software modules and/or computer applications. The input/output module 1224 is representative of software that is used to provide an interface with a device configured to capture inputs, such as a touchscreen, track pad, camera, microphone, and so on. Alternatively or in addition, the interface application 1222 and the input/output module 1224 can be implemented as hardware, software, firmware, or any combination thereof. Additionally, the input/output module 1224 may be configured to support multiple input devices, such as separate devices to capture visual and audio inputs, respectively.

Device 1200 also includes an audio and/or video input-output system 1226 that provides audio data to an audio system 1228 and/or provides video data to a display system 1230. The audio system 1228 and/or the display system 1230 can include any devices that process, display, and/or otherwise render audio, video, and image data. Video signals and audio signals can be communicated from device 1200 to an audio device and/or to a display device via an RF (radio frequency) link, S-video link, composite video link, component video link, DVI (digital video interface), analog audio connection, or other similar communication link. In an embodiment, the audio system 1228 and/or the display system 1230 are implemented as external components to device 1200. Alternatively, the audio system 1228 and/or the display system 1230 are implemented as integrated components of example device 1200.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device, the method comprising:
determining a user's orientation with respect to the computing device based at least in part on:
a part of the user that contacts the computing device; and
at least one other part of a user that does not contact the computing device; and
displaying a menu having an orientation on a display device of the computing device based at least in part on the determined user's orientation with respect to the computing device.

2. A method as described in claim 1, wherein the part of the user that contacts the computing device is part of a finger of the user's hand.

3. A method as described in claim 2, wherein the part of the user contacts the display device of the computing device.

4. A method as described in claim 2, wherein the at least one other part of the user that does not contact the computing device also is part of the user's arm.

5. A method as described in claim 1, wherein the determining is based at least in part by examining data captured by one or more sensors of the computing device.

6. A method as described in claim 5, wherein the one or more sensors include a camera and the data includes an image captured by the camera.

7. A method as described in claim 1, further comprising determining an order of priority to display the plurality of items in the menu; and wherein the displaying includes display of the plurality of items arranged according to the determined order such that a first said item has less of a likelihood of being obscured by a user that interacts with the display device than a second said item, the first said item having a priority in the order that is higher than a priority in the order of the second said item.

8. A method as described in claim 1, further comprising:
detecting whether a left or right hand of the user is being used to interact with the computing device; and
choosing an arrangement in which to display of the plurality of items based at least in part on detection of whether the left or right hand of the user is being used to interact with the computing device.

9. A method as described in claim 1, wherein the displaying of the menu is performed such that a plurality of hierarchical levels of the menu are displayable in succession and as having the orientation for the menu that is based at least in part on the determined user's orientation with respect to the computing device.

10. An apparatus comprising:
a display device; and
one or more modules implemented at least partially in hardware, the one or more modules configured to:
determine an order of priority to display a plurality of items in a hierarchical level of a menu; and
display the plurality of items on the display device arranged according to the determined order such that a first said item has less of a likelihood of being obscured by a user that interacts with the display device than a second said item, the first said item having a priority in the order that is higher than a priority in the order of the second said item.

11. An apparatus as described in claim 10, further comprising one or more sensors configured to capture data usable to determine an orientation of the user with respect to the apparatus and wherein the one or more modules are further configured to display the plurality of items at an orientation that is based at least in part on the determined orientation of the user.

12. An apparatus as described in claim 11, wherein the one or more sensors include a camera and the data includes an image captured by the camera.

13. An apparatus as described in claim 10, further comprising:
detecting whether a left or right hand of the user is being used to interact with the apparatus; and
choosing an arrangement in which to display of the plurality of items in the determined order based at least in part on detection of whether the left or right hand of the user is being used to interact with the apparatus.

14. An apparatus as described in claim 10, wherein the one or more modules are further configured to:
determine a user's orientation with respect to the computing device based at least in part on:
a part of the user that contacts the computing device; and
at least one other part of a user that does not contact the computing device; and
display a menu having an orientation on a display device of the computing device based at least in part on the determined user's orientation with respect to the computing device.

15. One or more computer-readable storage media comprising instructions stored thereon that, responsive to execution by a computing device, causes the computing device to generate a menu having a plurality of items that are selectable and arranged in a radial pattern for display on a display device of the computing device, the arrangement chosen by based at least in part on whether a left or right hand of the user is being used to interact with the display device.

16. One or more computer-readable storage media as described in claim 15, wherein the instructions are further executable to cause the computing device to:
determine an order of priority to display the plurality of items in the menu; and
cause the plurality of items to be displayed on the display device arranged according to the determined order such that a first said item has less of a likelihood of being obscured by a user that interacts with the display device than a second said item, the first said item having a priority in the order that is higher than a priority in the order of the second said item.

17. One or more computer-readable storage media as described in claim 15, wherein the instructions are further executable to cause the computing device to determine a user's orientation with respect to the computing device based on a part of the user that contacts the computing device.

18. One or more computer-readable storage media as described in claim 17, wherein the instructions are further executable to cause the computing device to determine the user's orientation with respect to the computing device also based on another part of a user that does not contact the computing device.

19. One or more computer-readable storage media as described in claim 18, wherein the instructions are further executable to cause the computing device to determine the orientation based on data obtained from one or more sensors of the computing device.

20. One or more computer-readable storage media as described in claim 19, wherein the one or more sensors include a camera and the data includes an image captured by the camera.
